(19) United States
(12) Patent Application Publication
(10) Pub. No.: US 2006/0081783 A1
(43) Pub. Date: Apr. 20, 2006

(54) Infrared detection apparatus and method for installing the same

(76) Inventor: Cholmin Seo, Otsu (JP)

Correspondence Address: WENDEROTH, LIND & PONACK, L.L.P., 2033 K STREET N. W., SUITE 800, WASHINGTON, DC, 20006-1021, US

(21) Appl. No.: 11/248,242

(22) Filed: Oct. 13, 2005

(30) Foreign Application Priority Data
Oct. 14, 2004 (JP) 2004-300228

(51) Int. Cl. G01T 1/161

(52) U.S. Cl. 250/363.02

(57) ABSTRACT

According to an embodiment, an infrared detection apparatus is provided which comprises a plurality of light receiving means for detecting infrared light and outputting a signal corresponding to the infrared light, and forms a plurality of detection areas adjacent to each other in space using the light receiving means. The apparatus comprises display means for displaying a direction and an amount, and control means for determining directions and amounts of deviation of the plurality of detection areas from respective appropriate locations based on a difference in each signal output from the plurality of light receiving means when a human body is detected, and letting the display means perform display depending on the directions and amounts of the deviation.

### CROSS-REFERENCE TO RELATED APPLICATIONS

This application claims priority under 35 U.S.C. §119(a) on Patent Application No. 2004-300228 filed in Japan on Oct. 14, 2004, the entire contents of which are hereby incorporated by reference.

### BACKGROUND OF THE INVENTION

1. Field of the Invention

The present invention relates to a passive infrared detection apparatus for detecting a person intruding an alert area by receiving infrared light emitted from the intruder, and a method for installing the same. More particularly, the present invention relates to an infrared detection apparatus for detecting an intruder at a building wall or window, and a method for installing the same.

2. Related Art

Conventionally, in such infrared detection apparatuses, far infrared light emitted from a human body is condensed with an optical element and the resultant light is received with a pyroelectric element or the like. An angular range within which an infrared detection apparatus can condense infrared light (two-dimensionally viewed from the top), i.e., a detection area, is generally divided into a plurality of pairs of plus and minus. The infrared detection apparatuses include wide sensors which are used to detect an intruder into a wide space, such as inside of a room or the like, and narrow sensors which are used to detect, for example, an intruder at a building wall or window or an intruder intruding through a window or a door facing a narrow passage. In the case of the wide sensor, a large number of the angular range are set for the detection area (e.g., 5 to 9 pairs) for the purpose of its use. By contrast, in the case of the narrow sensor, a small number such as one or two pairs of the angular range are set for the detection area.

A detection distance of the narrow sensor is generally set to be longer (by a factor of 1.5 to 2) than that of the wide sensor for the purpose of its use. Therefore, the narrow sensor has a lens assembly (a type of optical element) having a focal length longer than that of the wide sensor so that the width of an object to be detected (intruder) is the same as the width of the detection area at the maximum length (hereinafter referred to as a rated distance) at which the infrared detection apparatus can detect the object to be detected. Alternatively, the area of the lens assembly per detection area may be increased while not changing the focal length of the lens assembly, thereby increasing the amount of received light, and therefore, increasing the rated distance.

When the passive infrared detection apparatus is installed outdoors, a false operation may occur due to a heat source located farther than the detection area, direct sunlight, a small animal entering the detection area, or the like. A passive infrared human body detection apparatus capable of detecting only a human body with high accuracy while certainly avoiding such a false operation, has been proposed (e.g., JP H09-101376 A).

This passive infrared human body detection apparatus comprises two sensor units each of which has a light receiving element for converting incident infrared energy into an electrical signal corresponding to variations in the energy, and an optical system for condensing infrared light and letting the resultant light enter the light receiving element. In the sensor unit, a predetermined detection area is set based on a direction of light received by the optical system, and the light receiving element converts infrared energy emitted from the detection area into an electrical signal, depending on variations in the infrared energy. The first sensor unit is oriented to receive light from an upper half of a human body (an object to be detected), so that the detection area of the first sensor unit does not reach the ground. The second sensor unit is oriented so that the detection area thereof is located below the detection area of the first sensor unit and is directed to the ground at a predetermined detection distance from the installed position of the second sensor unit. The passive infrared human body detection apparatus further comprises level detecting circuits each of which outputs a detection signal when an output electrical signal from the light receiving element of a corresponding sensor unit exceeds a predetermined level, and a human body detecting circuit of outputting a human body detection signal when both the level detecting circuits output the detection signals. Note that it is also disclosed that, in the passive infrared human body detection apparatus, the detection distance can be suited for a size of an area to be alerted by adjusting a vertical direction of the second sensor unit.

On the other hand, an infrared detection apparatus has been proposed which has a function to display a state of a detection signal of a human body by letting a built-in LED operate or flicker, or an electronic buzzer to make a continuous or intermittent sound, as required when, for example, the infrared detection apparatus is installed or a periodical inspection is performed after installation (see, for example, JP 2004-185554 A). Such a display function is disabled during an ordinary operation, and is enabled only when, for example, the apparatus is installed. Further, there is an infrared detection apparatus as follows. When being installed, the infrared detection apparatus is connected to an external test equipment or the like so that a detection signal output from the infrared detection apparatus is input to an audio amplifying circuit of the external test equipment or the like, thereby changing the volume of a sound to be generated, depending on the detection signal. As a result, a state of the detection signal of a human body can be confirmed. An installer himself or herself actually walks within the detection area, while confirming whether or not he or she is located within the detection area by monitoring the display (or hearing a display sound), thereby adjusting, for example, the installed state of the infrared detection apparatus to obtain the detection area at an appropriate location.

Some of the infrared detection apparatuses have a long detection distance of, for example, more than 30 m. Particularly, some narrow sensors have a detection distance of 100 m. In the case of these long-distance detection infrared detectors, when the installation angle is changed by only one degree, the location of the detection area may be deviated by as large as several tens of centimeters. In this case, it is likely that an intruder cannot be certainly detected. Therefore, it is necessary that the detection area be carefully adjusted during installation.

However, as described above, when the infrared detection apparatus is installed, the detection area is only confirmed by the installer himself or herself actually walking within the detection area and determining based on the display whether or not the installer is detected. Since it cannot be correctly determined as to whether or not the detection area is deviated from an appropriate location, and the direction and amount of the deviation, the detection area cannot be necessarily always established at the appropriate location.

The principle of the passive infrared detection apparatus is to detect a difference in temperature between a human body and its surrounding. When the ambient temperature is sufficiently low like in winter, there is a large temperature difference between a human body and its surrounding, so that the detection of the human body may not be much influenced even when the detection area is deviated to some degree. However, when the ambient temperature is high like in summer, so that the temperature difference between a human body and its surrounding is small, the human body may not be detected, depending on the degree of deviation of the detection area.

Therefore, for example, when the infrared detection apparatus is installed in winter with the above-described method, it is likely that an intruder cannot be certainly detected in summer, depending on the amount of deviation of the detection area from the appropriate location.

### SUMMARY OF THE INVENTION

The present invention is achieved, paying attention to the above-described problems with the conventional technology. An object of the present invention is to provide an infrared detection apparatus capable of correctly determining whether or not a detection area is deviated from an appropriate location, and a direction and an amount of the deviation, and being installed so that the detection area is established at an appropriate location irrespective of an environmental condition, such as ambient temperature or the like, and a method for installing the same.

In order to achieve the object of the present invention, an infrared detection apparatus comprises a plurality of light receiving means for detecting infrared light and outputting a signal corresponding to the infrared light, the apparatus forming a plurality of detection areas adjacent to each other in space using the light receiving means. The apparatus comprises display means for displaying a direction, and control means for determining directions of deviation of the plurality of detection areas from respective appropriate locations based on a difference in each signal output from the plurality of light receiving means when a human body is detected, and letting the display means perform display depending on the directions of the deviation.

Examples of the display means include means for performing visual display which can be recognized by visual sense, means for performing auditory display which can be recognized by auditory sense, means for performing visual and auditory display, and the like. Specifically, examples of the visual display means include means including a light emitting element, means including a plurality of light emitting elements arranged in a direction along which the plurality of detection areas are adjacent to each other. As the light emitting element, a light emitting diode may be used, for example. As the auditory display means, means for generating a sound and capable of changing a tone and/or volume of the sound is preferable.

According to the infrared detection apparatus of the present invention, it is possible for the installer to correctly determine the direction of the deviation, based on the display by the display means, when the detection areas are deviated from the respective appropriate locations. Thereby, the detection areas can be easily established at the respective appropriate locations. As a result, the workability is improved, thereby making it possible to, for example, reduce a time required for the task. The infrared detection apparatus thus installed can certainly detect an intruder irrespective of an environmental condition, since the detection areas are provided at the respective appropriate locations.

An infrared detection apparatus of the present invention comprises a plurality of light receiving means for detecting infrared light and outputting a signal corresponding to the infrared light, the apparatus forming a plurality of detection areas adjacent to each other in space using the light receiving means. The apparatus may comprise display means for displaying a direction and an amount, and control means for determining directions and amounts of deviation of the plurality of detection areas from respective appropriate locations based on a difference in each signal output from the plurality of light receiving means when a human body is detected, and letting the display means perform display depending on the directions and amounts of the deviation.

According to the infrared detection apparatus of the present invention, it is possible for the installer to correctly determine the direction and amount of the deviation, based on the display by the display means, when the detection areas are deviated from the respective appropriate locations. Thereby, the detection areas can be more easily established at the respective appropriate locations. As a result, the workability is further improved, thereby making it possible to, for example, further reduce a time required for the task. The infrared detection apparatus thus installed can certainly detect an intruder irrespective of an environmental condition, since the detection areas are provided at the respective appropriate locations.

Alternatively, in order to achieve the object of the present invention, a method for installing an infrared detection apparatus comprising a plurality of light receiving means for detecting infrared light and outputting a signal corresponding to the infrared light, the apparatus forming a plurality of detection areas adjacent to each other in space using the light receiving means, is provided. The method comprises the steps of determining directions of deviation of the plurality of detection areas from respective appropriate locations based on a difference in each signal output from the plurality of light receiving means when a human body is detected, performing direction display depending on the directions of the deviation determined by the determining step, and changing an installed state of the infrared detection apparatus based on the direction display provided by the display performing step.

According to the method for installing the infrared detection apparatus of the present invention, it is possible for the installer to correctly determine the direction of the deviation, based on the display of the display performing step, when the detection areas are deviated from the respective appropriate locations. Thereby, the detection areas can be easily established at the respective appropriate locations. As a result, the workability is improved, thereby making it possible to, for example, reduce a time required for the task.

The present invention also provides a method for installing an infrared detection apparatus comprising a plurality of light receiving means for detecting infrared light and outputting a signal corresponding to the infrared light, the apparatus forming a plurality of detection areas adjacent to each other in space using the light receiving means, the method comprising the steps of determining directions and amounts of deviation of the plurality of detection areas from respective appropriate locations based on a difference in each signal output from the plurality of light receiving means when a human body is detected, performing display of a direction and amount depending on the directions and amounts of the deviation determined by the determining step, and changing an installed state of the infrared detection apparatus based on the direction and amount display provided by the display performing step.

According to the method for installing the infrared detection apparatus of the present invention, it is possible for the installer to correctly determine the direction and amount of the deviation, based on the display of the display performing step, when the detection areas are deviated from the respective appropriate locations. Thereby, the detection areas can be more easily established at the respective appropriate locations. As a result, the workability is further improved, thereby making it possible to, for example, further reduce a time required for the task.

### BRIEF DESCRIPTION OF THE DRAWINGS

FIGS. 1(a) to 1(c) are external views of a far infrared security sensor according to a first embodiment of the present invention. FIG. 1(a) is a plan view, FIG. 1(b) is a front view, and FIG. 1(c) is a left side view.

FIG. 2 is a block diagram illustrating only parts of the far infrared security sensor of the first embodiment of the present invention, which are related to the present invention.

FIG. 3 is a diagram for explaining a positional relationship between detection areas of the far infrared security sensor of the first embodiment of the present invention and a human body when the detection areas are provided at respective appropriate locations.

FIG. 4(a) and FIG. 4(b) are diagrams illustrating an exemplary output signal of each light receiver when a human body crosses the detection areas of the light receivers in the situation of FIG. 3. FIG. 4(a) indicates an output signal of the upper light receiver, while FIG. 4(b) indicates an output signal of the lower light receiver.

FIG. 5 is a diagram for explaining a positional relationship between detection areas of the far infrared security sensor of the first embodiment of the present invention and a human body when the detection areas are deviated from respective appropriate locations.

FIG. 6(a) and FIG. 6(b) are diagrams illustrating an exemplary output signal of each light receiver when a human body crosses the detection areas of the light receivers in the situation of FIG. 5. FIG. 6(a) indicates an output signal of the upper light receiver, while FIG. 6(b) indicates an output signal of the lower light receiver.

FIG. 7 is a flowchart schematically illustrating an operation of the far infrared security sensor of the first embodiment of the present invention during installation or the like.

FIG. 8 is a block diagram illustrating only parts of a far infrared security sensor according to a second embodiment of the present invention, which are related to the present invention, and an external test equipment.

### DESCRIPTION OF THE PREFERRED EMBODIMENTS

Hereinafter, embodiments of the present invention will be described with reference to the accompanying drawings.

### First Embodiment

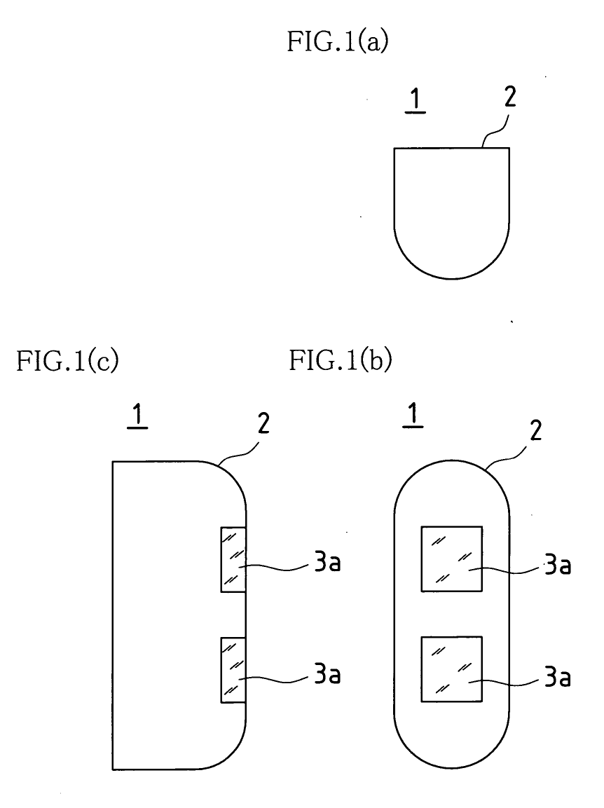

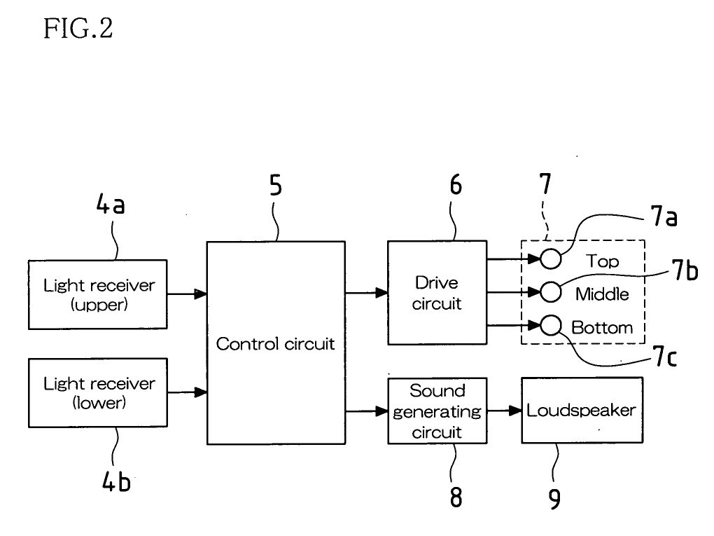

FIGS. 1(a) to 1(c) are external views of a far infrared security sensor 1 according to a first embodiment of the present invention. FIG. 1(a) is a plan view, FIG. 1(b) is a front view, and FIG. 1(c) is a left side view. FIG. 2 is a block diagram illustrating only parts of the far infrared security sensor 1 which are related to the present invention.

As illustrated in FIGS. 1(a) to 1(c), the far infrared security sensor 1 has a case 2 which can be attached to a wall surface or the like. Lenses 3a and 3b through which far infrared light is transmitted are provided at an upper portion and a lower portion of a front side of the case 2, respectively. At the back of each lens, two light receivers of different systems described below are provided. Thus, two upper and lower detection areas are created toward the front side of the far infrared security sensor 1.

Note that the lower light receiver may be held by a mechanism (not shown) in the case 2 in a manner which allows the lower light receiver to vertically move within a predetermined range. With this structure, a relative positional relationship between the lower light receiver and the lens 3b can be changed, so that a formation direction of the lower detection area can be changed within a predetermined range. An exemplary specific internal structure of the far infrared security sensor 1 in this case is disclosed, for example, in JP H09-101376 A described above.

Further, as illustrated in FIG. 2, the far infrared security sensor 1 comprises two light receivers 4a (upper) and 4b (lower) of different systems, each of which has a pyroelectric element for detecting far infrared light or the like and generates an output depending on the detected far infrared light, a display section 7 which has three LEDs 7a, 7b and 7c arranged vertically (7a, top), a drive circuit 6 which operates each LED of the display section 7, a loudspeaker 9 which outputs a sound, a sound generating circuit 8 which sets the volume and tone of a sound output by the loudspeaker 9 (e.g., any of “do, re, mi, fa, and sol” is selected), and a control circuit 5 which controls the drive circuit 6 and the sound generating circuit 8 based on the outputs of the light receivers 4a and 4b.

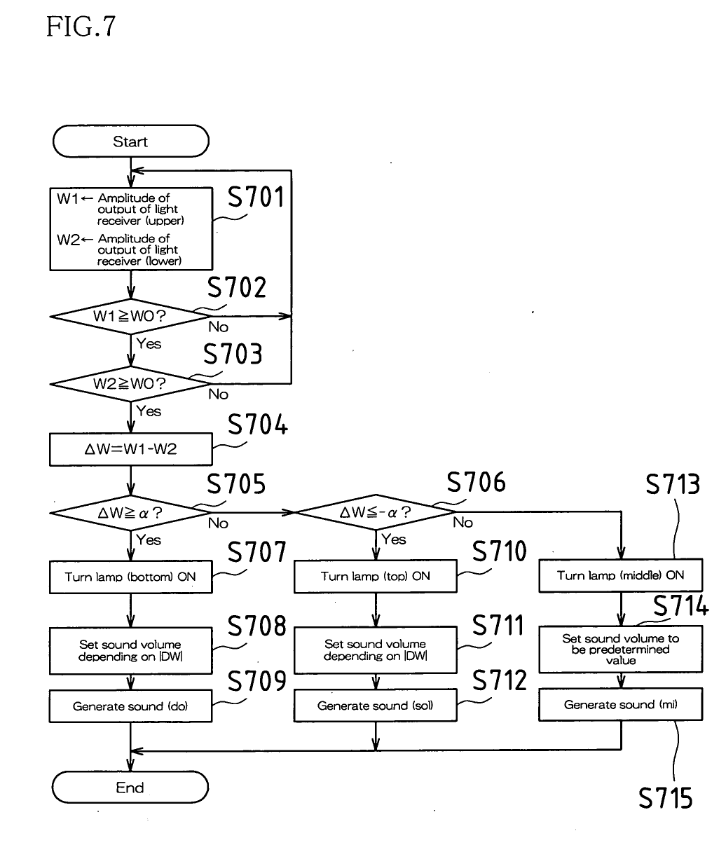

Examples of the control circuit 5 include, but are not limited to, a one-chip microcomputer, an FPGA, an ASIC, and the like. If the control of the whole far infrared security sensor 1 is performed by, for example, a one-chip microcomputer, the control circuit 5 may also be achieved by the one-chip microcomputer. Alternatively, the control circuit 5 may be a separate circuit. Note that a detailed operation of the control circuit 5 will be described below with reference to FIG. 7.

The number of LEDs included in the display section 7 is not limited to three, and may be larger than three, or alternatively, the display states of two LEDs may be combined. Alternatively, a 7-segment LED or the like may be used to display numerals or the like, or a liquid crystal panel or the like is used to provide dot-matrix display capable of displaying characters and numerals.

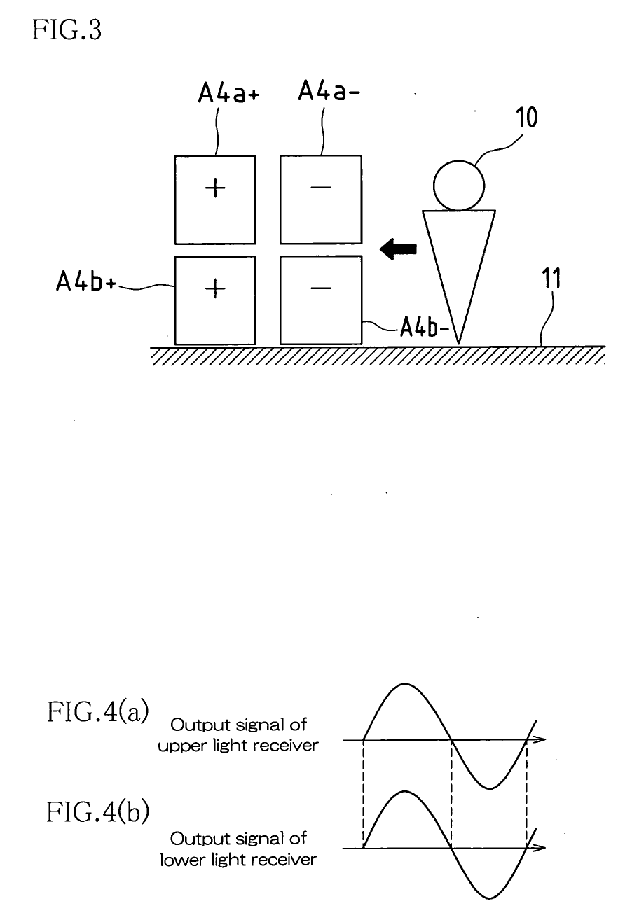

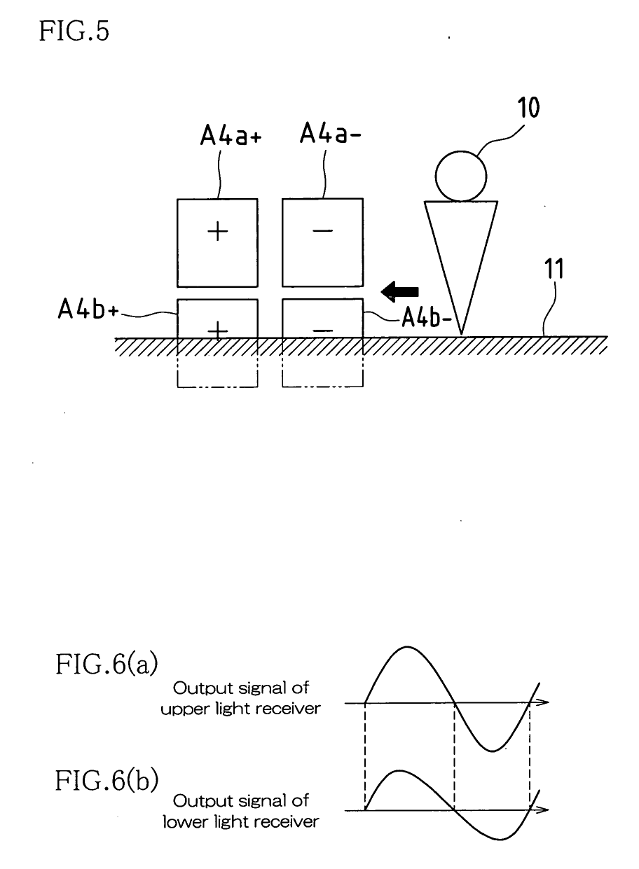

FIG. 3 is a diagram for explaining a positional relationship between detection areas of the far infrared security sensor 1 of the first embodiment of the present invention and a human body when the detection areas are provided at respective appropriate locations. FIG. 4(a) and FIG. 4(b) illustrate an exemplary output signal of each light receiver when a human body crosses the detection areas of the light receivers in the situation of FIG. 3. FIG. 4(a) indicates an output signal of the upper light receiver 4a, while FIG. 4(b) indicates an output signal of the lower light receiver 4b. FIG. 5 is a diagram for explaining a positional relationship between detection areas of the far infrared security sensor 1 of the first embodiment of the present invention and a human body when the detection areas are deviated from respective appropriate locations. FIG. 6(a) and FIG. 6(b) illustrate an exemplary output signal of each light receiver when a human body crosses the detection areas of the light receivers in the situation of FIG. 5. FIG. 6(a) indicates an output signal of the upper light receiver 4a, while FIG. 6(b) indicates an output signal of the lower light receiver 4b.

When the far infrared security sensor 1 is installed with the detection areas thereof provided at respective appropriate locations, upper detection areas A4a+ and A4a− (a pair of plus and minus) are formed at a location corresponding to an upper half of a human body 10 and horizontally adjacent to each other as illustrated in FIG. 3. Lower detection areas A4b+ and A4b− are formed at a location corresponding to a lower half of the human body 10, horizontally adjacent to each other, and between the upper detection areas A4a+ and A4a− and ground 11.

In this situation, when the human body 10 crosses these detection areas, the upper light receiver 4a and the lower light receiver 4b output sine wave-like signals having substantially the same amplitude as illustrated in FIG. 4(a) and FIG. 4(b).

On the other hand, when the far infrared security sensor 1 is installed with the detection areas deviated from the respective appropriate locations (e.g., the whole far infrared security sensor 1 attached to a wall surface is slightly inclined downward, etc.), the upper detection areas A4a+ and A4a− and the lower detection areas A4b+ and A4b− are formed at respective locations deviated by respective predetermined amounts as compared to the formation locations of FIG. 3, as illustrated in FIG. 5. In this case, substantially the entirety of the upper detection areas A4a+ and A4a− still correspond to the human body 10, however, only portions of the lower detection areas A4b+ and A4b− correspond to the human body 10, i.e., the other portions do not correspond to the human body 10.

In this situation, when the human body 10 crosses these detection areas, the upper light receiver 4a outputs a sine wave-like signal having substantially the same amplitude as that of FIG. 4(a), as illustrated in FIG. 6(a). However, since the lower light receiver 4b corresponds to only a portion of the lower half of the human body 10, the lower light receiver 4b outputs a sine wave-like signal having an amplitude of smaller than that of FIG. 6(a), as illustrated in FIG. 6(b).

As described above, when the detection areas are deviated from the respective appropriate locations, it is likely that the far infrared security sensor 1 cannot detect the human body 10, depending on the ambient temperature. Therefore, as described below, the far infrared security sensor 1 performs display using light and sound so that the installer can correctly determine whether or not the detection areas are deviated from the respective appropriate locations, and a direction and an amount of the deviation.

FIG. 7 is a flowchart schematically illustrating an operation of the far infrared security sensor 1 of the first embodiment of the present invention during installation or the like.

As illustrated in FIG. 7, when the far infrared security sensor 1 is switched to an operated state for installation or the like, output signals of the light receivers 4a and 4b are monitored. When these output signals are changed by the human body 10 or the like crossing the detection areas, amplitudes of the output signals are stored in variables W1 and W2, respectively (step S701).

However, when the output signal is changed but the amplitude is small, there is a possibility that the human body 10 or the like did not cross the detection areas, and an influence, such as other factors, noise or the like, is responsible for the change of the output signal. In such a case, it is desirable that the influence be ignored so as to prevent a false operation. Therefore, the value in the variable W1 is compared with a predetermined reference value W0 (step S702). If “W1≧W0”, the process goes to step S703, and if not, the process returns to step S701. In step S703, the value in the variable W2 is compared with the predetermined reference value W0 (step S703). If “W2≧W0”, the process goes to step S704, and if not, the process returns to step S701. In other words, if the values in the variable W1 and the variable W2 are both larger than or equal to W0, the process goes to step S704, and when at least one of the values in the variables W1 and W2 is smaller than W0, the process returns to step S701.

Next, a value obtained by subtracting the value in the variable W2 from the value in the variable W1 is substituted into a variable ΔW (step S704). Based on the value in the variable ΔW, it is determined whether the amplitudes of the output signals of the light receivers 4a and 4b are substantially the same (the amplitude difference is less than a predetermined value) or one of them is larger than the other. Based on the result of the determination, the display state of each LED of the display section 7 and the volume and tone of a sound output by the loudspeaker 9 are set.

Specifically, the value in the variable ΔW is compared with a predetermined value a (note that α>0) (step S705). If “ΔW≧α”, the process goes to step S707, and if not, the process goes to step S706. In step S706, the value in the variable ΔW is compared with −α. If “ΔW≦−α”, the process goes to step S710, and if not, the process goes to step S713.

When the process goes to step S707, the amplitude of the output signal of the upper light receiver 4a is larger, by the predetermined value a or more, than the amplitude of the output signal of the lower light receiver 4b. In this case, for example, as illustrated in FIG. 5, since the far infrared security sensor 1 is inclined slightly downward, each detection area is deviated downward from the appropriate location, so that it is believed that only in a portion of the lower detection areas, far infrared light from the human body 10 can be detected. Therefore, in order to inform the installer of such a situation, the lower LED 7c of the display section 7 is turned ON (step S707). Further, the volume of a sound is set, depending on the absolute value of the variable ΔW, to be increased with an increase in the amount of deviation (step S708). As the tone of the sound, a lower tone “do” is selected and output from the loudspeaker 9 (step S709).

When the process goes to step S710, the amplitude of the output signal of the upper light receiver 4a is smaller, by the predetermined value a or more, than the amplitude of the output signal of the lower light receiver 4b. In other words, the amplitude of the output signal of the lower light receiver 4b is larger, by the predetermined value a or more, than the amplitude of the output signal of the upper light receiver 4a. In this case, since the far infrared security sensor 1 is inclined slightly upward, each detection area is deviated upward from the appropriate location, so that it is believed that only in a portion of the upper detection areas, far infrared light from the human body 10 can be detected. Therefore, in order to inform the installer of such a situation, the upper LED 7a of the display section 7 is turned ON (step S710). Further, the volume of a sound is set, depending on the absolute value of the variable ΔW, to be increased with an increase in the amount of deviation (step S711). As the tone of the sound, a higher tone “sol” is selected and output from the loudspeaker 9 (step S712).

When the process goes to step S713, the difference between the amplitude of the output signal of the upper light receiver 4a and the amplitude of the output signal of the lower light receiver 4b is smaller than the predetermined value α, i.e., these amplitudes are substantially the same. In this case, the inclination of the far infrared security sensor 1 is substantially zero, so that it is considered that each detection area is provided at substantially the appropriate location, and far infrared light from the human body 10 can be detected in each entire detection area. Therefore, in order to inform the installer of such a situation, the middle LED 7b of the display section 7 is turned ON (step S713). Further, the volume of a sound is set to be a predetermined value (step S714), and as the tone of the sound, a middle tone “mi” is selected and output from the loudspeaker 9 (step S715).

In the above-described manner, the adjustment of the installed state of the far infrared security sensor 1 is repeated as required, while confirming whether or not the detection areas are deviated from the respective appropriate locations, and the direction and amount of the deviation with reference to light and sound display. When display is performed in accordance with steps S713 to S715, it is determined that the detection areas are established at the respective appropriate locations, and the installation task is ended.

Note that if the number of LEDs possessed by the display section 7 is larger than three, the determination in steps S705 and S706 may be changed to be performed on multiple scales, and the light and sound display may be performed more finely. When the number of LEDs possessed by the display section 7 is two, the lower LED may be turned ON in step S707, the upper LED may be turned ON in step S710, and both the LEDs may be simultaneously turned ON in step S713.

Even when the detection areas are provided at the respective appropriate locations, the amplitude of the output signal of the upper light receiver 4a is not strictly the same as the amplitude of the output signal of the lower light receiver 4b due to, for example, a difference between the upper and lower halves of the human body 10. Therefore, in consideration of this, the determination in step S705 may be performed using α, and the determination in step S706 may be performed using, for example, −β (note that β>0) instead of −α (β is different from α).

According to the above-described structure of the first embodiment of the present invention, it is possible for the installer to correctly determine whether or not the detection areas of the far infrared security sensor 1 are deviated from the respective appropriate locations, and the direction and amount of the deviation, based on the light and sound display. Thereby, the detection areas can be established easily at the respective appropriate locations irrespective of an environmental condition, such as ambient temperature or the like. As a result, the workability is improved, thereby making it possible to, for example, reduce a time required for the task. The far infrared security sensor 1 thus installed can certainly detect an intruder irrespective of the environmental condition, since the detection areas are provided at the respective appropriate locations.

### Second Embodiment

In the above-described first embodiment, the far infrared security sensor 1 comprises the drive circuit 6, the display section 7, the sound generating circuit 8, and the loudspeaker 9. However, these parts may not be used during an ordinary operation, depending on the primary specification or function of the far infrared security sensor 1, and may be used only during installation or the like.

In consideration of this, a far infrared security sensor 1A according to a second embodiment of the present invention does not comprise the drive circuit 6, the display section 7, the sound generating circuit 8, and the loudspeaker 9, and instead, these parts are included in an external test equipment 12. Hereinafter, the far infrared security sensor 1A will be described. Note that the same parts as those of the first embodiment are indicated with the same reference numerals and a difference point will be mainly described.

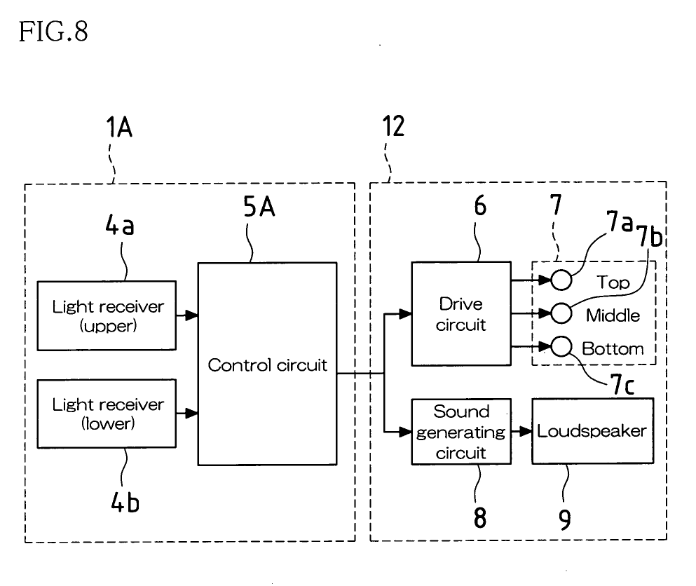

FIG. 8 is a block diagram illustrating only parts that are related to the present invention of the far infrared security sensor 1A according to the second embodiment of the present invention, and the external test equipment 12.

As illustrated in FIG. 8, the far infrared security sensor 1A comprises two light receivers 4a (upper) and 4b (lower) of different systems, each of which has a pyroelectric element for detecting far infrared light or the like and generates an output depending on the detected far infrared light, and a control circuit 5A which performs a control based on the outputs of the light receivers 4a and 4b.

On the other hand, the external test equipment 12 comprises a display section 7 which has three LEDs 7a, 7b and 7c arranged vertically (7a, top), a drive circuit 6 which operates each LED of the display section 7, a loudspeaker 9 which outputs a sound, and a sound generating circuit 8 which sets the volume and tone of a sound output by the loudspeaker 9 (e.g., any of “do, re, mi, fa, and sol” is selected).

When the far infrared security sensor 1A is connected to the external test equipment 12, the control circuit 5A of the far infrared security sensor 1A can control the drive circuit 6 and the sound generating circuit 8 of the external test equipment 12. Note that the specific operation of the control circuit 5A is performed in a manner similar to that of FIG. 7.

According to the above-described structure of the second embodiment of the present invention, it is possible for the installer to correctly determine whether or not the detection areas of the far infrared security sensor 1A are deviated from the respective appropriate locations, and the direction and amount of the deviation, based on light and sound display. Thereby, the detection areas can be established easily at the respective appropriate locations irrespective of an environmental condition, such as ambient temperature or the like. As a result, the workability is improved, thereby making it possible to, for example, reduce a time required for the task. The far infrared security sensor 1A thus installed can certainly detect an intruder irrespective of the environmental condition, since the detection areas are provided at the respective appropriate locations. In addition, the far infrared security sensor 1A does not comprise the drive circuit 6, the display section 7, the sound generating circuit 8, and the loudspeaker 9, thereby making it possible to miniaturize the far infrared security sensor 1A and reduce its manufacturing cost.

The present invention can be embodied and practiced in other different forms without departing from the purport and essential characteristics thereof. Therefore, the above-described embodiments are considered in all respects as illustrative and not restrictive. The scope of the invention is indicated by the appended claims rather than by the foregoing description. All variations and modifications falling within the equivalency range of the appended claims are intended to be embraced therein.

1. An infrared detection apparatus comprising a plurality of light receiving means for detecting infrared light and outputting a signal corresponding to the infrared light, the apparatus forming a plurality of detection areas adjacent to each other in space using the light receiving means, the apparatus comprising:
display means for displaying a direction; and
control means for determining directions of deviation of the plurality of detection areas from respective appropriate locations based on a difference in each signal output from the plurality of light receiving means when a human body is detected, and letting the display means perform display depending on the directions of the deviation.

2. An infrared detection apparatus comprising a plurality of light receiving means for detecting infrared light and outputting a signal corresponding to the infrared light, the apparatus forming a plurality of detection areas adjacent to each other in space using the light receiving means, the apparatus comprising:
display means for displaying a direction and an amount; and
control means for determining directions and amounts of deviation of the plurality of detection areas from respective appropriate locations based on a difference in each signal output from the plurality of light receiving means when a human body is detected, and letting the display means perform display depending on the directions and amounts of the deviation.

3. The infrared detection apparatus according to claim 1, wherein the display means provides visual display which can be recognized by visual sense.

4. The infrared detection apparatus according to claim 1, wherein the display means provides auditory display which can be recognized by auditory sense.

5. The infrared detection apparatus according to claim 1, wherein the display means provides visual display which can be recognized by visual sense and auditory display which can be recognized by auditory sense.

6. The infrared detection apparatus according to claim 3, wherein the display means includes a light emitting element.

7. The infrared detection apparatus according to claim 3, wherein the display means includes a plurality of light emitting elements arranged in a direction along which the plurality of detection areas are adjacent to each other.

8. The infrared detection apparatus according to claim 6, wherein the light emitting element is a light emitting diode.

9. The infrared detection apparatus according to claim 4, wherein the display means is capable of generating a sound.

10. The infrared detection apparatus according to claim 9, wherein the display means is capable of changing a tone of the sound to be generated.

11. The infrared detection apparatus according to claim 9, wherein the display means is capable of changing a volume of the sound to be generated.

12. The infrared detection apparatus according to claim 9, wherein the display means is capable of changing a tone and a volume of the sound to be generated.

13. A method for installing an infrared detection apparatus comprising a plurality of light receiving means for detecting infrared light and outputting a signal corresponding to the infrared light, the apparatus forming a plurality of detection areas adjacent to each other in space using the light receiving means, the method comprising the steps of:
determining directions of deviation of the plurality of detection areas from respective appropriate locations based on a difference in each signal output from the plurality of light receiving means when a human body is detected;
performing direction display depending on the directions of the deviation determined by the determining step; and
changing an installed state of the infrared detection apparatus based on the direction display provided by the display performing step.

14. A method for installing an infrared detection apparatus comprising a plurality of light receiving means for detecting infrared light and outputting a signal corresponding to the infrared light, the apparatus forming a plurality of detection areas adjacent to each other in space using the light receiving means, the method comprising the steps of:
determining directions and amounts of deviation of the plurality of detection areas from respective appropriate locations based on a difference in each signal output from the plurality of light receiving means when a human body is detected;
performing display of a direction and amount depending on the directions and amounts of the deviation determined by the determining step; and
changing an installed state of the infrared detection apparatus based on the direction and amount display provided by the display performing step.

15. The infrared detection apparatus according to claim 2, wherein the display means provides visual display which can be recognized by visual sense.

16. The infrared detection apparatus according to claim 2, wherein the display means provides auditory display which can be recognized by auditory sense.

17. The infrared detection apparatus according to claim 2, wherein the display means provides visual display which can be recognized by visual sense and auditory display which can be recognized by auditory sense.

18. The infrared detection apparatus according to claim 15, wherein the display means includes a light emitting element.

19. The infrared detection apparatus according to claim 15, wherein the display means includes a plurality of light emitting elements arranged in a direction along which the plurality of detection areas are adjacent to each other.

20. The infrared detection apparatus according to claim 19, wherein the light emitting element is a light emitting diode.

21. The infrared detection apparatus according to claim 16, wherein the display means is capable of generating a sound.

22. The infrared detection apparatus according to claim 21, wherein the display means is capable of changing a tone of the sound to be generated.

23. The infrared detection apparatus according to claim 21, wherein the display means is capable of changing a volume of the sound to be generated.

24. The infrared detection apparatus according to claim 21, wherein the display means is capable of changing a tone and a volume of the sound to be generated.
